(19) United States
(12) Patent Application Publication
(10) Pub. No.: US 2026/0025270 A1
(43) Pub. Date: Jan. 22, 2026

(54) DEVICE AND METHOD FOR PROVISIONING A SECURITY KEY FOR VEHICLE CONTROL

(71) Applicants: HYUNDAI MOTOR COMPANY, Seoul (KR); KIA CORPORATION, Seoul (KR); HYUNDAI AUTOEVER CORP., Seoul (KR)

(72) Inventors: Ho Jin Jung, Hwaseong-si (KR); Seung Yeon Jeong, Hwaseong-si (KR); Young June Lee, Anyang-si (KR)

(73) Assignees: HYUNDAI MOTOR COMPANY, Seoul (KR); KIA CORPORATION, Seoul (KR); HYUNDAI AUTOEVER CORP., Seoul (KR)

(21) Appl. No.: 19/013,942

(22) Filed: Jan. 8, 2025

(30) Foreign Application Priority Data
Jul. 19, 2024 (KR) 10-2024-0095757

(51) Int. Cl. H04L 9/08

(52) U.S. Cl. CPC H04L 9/088

(57) ABSTRACT

A device for provisioning a security key for vehicle control includes at least one processor and a hardware security module (HSM) including at least one memory storing at least one program executable by the at least one processor. The at least one processor may be configured to determine an operating mode of an HSM operating firmware stored in the memory and selectively use an obfuscated security key included in the HSM operating firmware based on the operating mode of the HSM operating firmware.

### CROSS-REFERENCE TO RELATED APPLICATION

This application claims priority to and the benefit of Korean Patent Application No. 10-2024-0095757, filed on Jul. 19, 2024, the entire contents of which are hereby incorporated herein by reference.

### TECHNICAL FIELD

The present disclosure relates to device and method for provisioning a security key for vehicle control.

### BACKGROUND

Vehicle built-in systems use a hardware security module (HSM) to manage security keys of a vehicle. Various security keys used for security functions have to be injected at a stage prior to production. As one example, when a provisioning service provided by a semiconductor manufacturer is used, a provisioning process has to be performed in conjunction with a key management system (KMS) and at a production process stage. Accordingly, depending on the performance of the vehicle built-in system, a process time increases, a manufacturing process becomes complex, and the costs increase. As one of the existing methods used to solve the problems, there is a method in which an HSM provider pre-injects an unencrypted security key (pre-shared Key (PSK)) into the HSM firmware binary and distributes HSM firmware to developers.

When the HSM provider distributes the HSM firmware binary including the security key, since a key provisioning stage is omitted during a vehicle control process, cost and time may be saved. However, because the security key is embedded in the binary, there is a problem that the security of the security key is vulnerable. For example, during development stage of a controller for the vehicle built-in system, developers can extract an address and a security key value of the corresponding security key through reverse analysis.

### SUMMARY

Embodiments of the present disclosure provide a device and method for security key provisioning for vehicle control capable of preventing security key hacking that may occur during the development and production of the vehicle control device or a hardware security module (HSM) in advance.

Technical problems to be solved in the present disclosure are not limited to the above-mentioned technical problems Other technical problems that are not mentioned herein should be more clearly understood by those of ordinary skill in the art to which the present disclosure pertains from the following description.

According to one aspect of the present disclosure, there is provided a vehicle control device for provisioning a security key is provided. The vehicle control device for provisioning a security key includes at least one processor and a hardware security module (HSM) including at least one memory storing at least one program executed by the at least one processor. The processor is configured to determine an operating mode of an HSM operating firmware stored in the memory and selectively use an obfuscated security key included in the HSM operating firmware based on the determined operating mode.

According to an embodiment of the present disclosure, the processor may install and execute the HSM operating firmware including the obfuscated security key provided by the HSM from an HSM build server before determining the operating mode.

According to an embodiment of the present disclosure, the HSM build server may obfuscate a security key generated in a key management system (KMS) and generate the obfuscated security key.

According to an embodiment of the present disclosure, the HSM build server may generate an obfuscation key and obfuscate the security key using the generated obfuscation key.

According to an embodiment of the present disclosure, the HSM build server may generate the obfuscation key using at least one of the identification information (e.g., a unique ID of the HSM build server) used to request a security key from the KMS, a unique ID of the HSM, and a unique ID of the vehicle control device in which the HSM will be used.

According to an embodiment of the present disclosure, the HSM build server may inject the security key obfuscated using the obfuscation key into the HSM operating firmware.

According to an embodiment of the present disclosure, the processor may use one of the obfuscated security key and a public test security key depending on the operating mode of the HSM operating firmware.

According to an embodiment of the present disclosure, the operating mode of the HSM operating firmware may include a development mode corresponding to a stage of developing the vehicle control device and a production mode corresponding to a stage of mass producing the vehicle control device.

According to an embodiment of the present disclosure, the processor may use the public test security key when the operating mode of the HSM operating firmware is determined as the development mode.

According to an embodiment of the present disclosure, the processor may be configured to generate the obfuscation key when the operating mode of the HSM operating firmware is determined as the production mode, de-obfuscate the obfuscated security key using the generated obfuscation key, and replace a test security key used in the development mode with the de-obfuscated security key.

According to an embodiment of the present disclosure, the processor may be configured to determine whether there is a history of previously generating the obfuscation key when the operating mode of the HSM operating firmware is determined as the production mode and generate the obfuscation key when it is determined that there is no history of previously generating the obfuscation key.

According to an embodiment of the present disclosure, the processor may use the replaced security key when it is determined that there is the history of previously generating the obfuscation key.

According to an embodiment of the present disclosure, the processor may generate an obfuscation key identical to an obfuscation key used when generating the obfuscated security key in an HSM build server.

According to an embodiment of the present disclosure, the processor may generate the obfuscation key using at least one of identification information (e.g., a unique ID of the HSM build server) used when requesting the KMS to generate the security key, a unique ID of the HSM, and a unique ID of the vehicle control device in which the HSM will be used.

According to another aspect of the present disclosure, a method of provisioning a security key for vehicle control is provided. The method includes determining, by a hardware security module (HSM) including a processor, an operating mode of an HSM operating firmware. The method also includes selectively using, by the HSM, an obfuscated security key included in the HSM operating firmware based on the determined operating mode.

According to an embodiment of the present disclosure, the method may further include, prior to the determining, receiving, installing and executing, by the HSM, the HSM operating firmware including the obfuscated security key from the HSM build server.

According to an embodiment of the present disclosure, selectively using the obfuscated security key may include using one of the obfuscated security key and a public test key depending on the operating mode of the HSM operating firmware.

According to an embodiment of the present disclosure, selectively using the obfuscated security key may include using a public test security key when it is determined that the operating mode is the development mode in the determining.

According to an embodiment of the present disclosure, selectively using the obfuscated security key may include generating an obfuscation key when it is determined that the operating mode is the mass production mode, de-obfuscating the obfuscated security key using the generated obfuscation key, and replacing a test security key used in the development mode with the de-obfuscated security key and using the de-obfuscated security key.

According to an embodiment of the present disclosure, selectively using the obfuscated security key may further include determining whether there is a history of previously generating the obfuscation key when it is determined that the operating mode is the mass production mode in the determining, and in the generating of the obfuscation key, the obfuscation key may be generated when it is determined that there is no history of previously generating the obfuscation key.

According to an embodiment of the present disclosure, selectively using the obfuscated security key may further include using the replaced security key when it is determined that there is the history of previously generating the obfuscation key.

According to an embodiment of the present disclosure, generating the obfuscation key may include generating an obfuscation key identical to an obfuscation key used when generating the obfuscated security key in an HSM build server.

The features briefly summarized above with respect to the present disclosure are only illustrative aspects of the detailed description of the present disclosure described below, and do not limit the scope of the present disclosure.

### BRIEF DESCRIPTION OF THE DRAWINGS

The above and other objects, features, and advantages of the present disclosure should become more apparent to those of ordinary skill in the art from the following description taken in conjunction with the accompanying drawings, in which:

FIG. 1 is a view illustrating a vehicle transmitting and receiving data by communicating with another device according to an embodiment of the present disclosure;

FIG. 2 is a diagram showing modules constituting a vehicle according to an embodiment of the present disclosure;

FIG. 3 is a diagram showing a security key provisioning system for vehicle control according to an embodiment of the present disclosure;

FIG. 4 is a block diagram showing a hardware security module (HSM) build server for security key provisioning shown in FIG. 3, according to an embodiment of the present disclosure;

FIG. 5 is a block diagram showing a vehicle control device for security key provisioning shown in FIG. 3, according to an embodiment of the present disclosure;

FIG. 6 is a diagram for describing a configuration of a second processor of the vehicle control device according to an embodiment of the present disclosure;

FIG. 7 is a flowchart for describing a method of generating a security key for security key provisioning according to an embodiment of the present disclosure; and

FIG. 8 is a flowchart for describing a method of provisioning a security key for vehicle control by a vehicle control device according to an embodiment of the present disclosure.

### DETAILED DESCRIPTION

Hereinafter, embodiments of the present disclosure are described in detail with reference to the accompanying drawings to enable those having ordinary skill in the art to which the present disclosure pertains to easily implement the embodiments of the present disclosure. However, the present disclosure may be implemented in many different forms and is not limited to the embodiments described herein.

Furthermore, in describing embodiments of the present disclosure, when it was determined that a detailed description of a known configuration or function may obscure the subject matter of the present disclosure, the detailed description thereof has been omitted. In addition, in the drawings, parts that are not related to the description of the present disclosure are omitted, and similar parts are given similar reference numerals.

In the present disclosure, when a component is referred to as being “connected to,” “coupled to,” or “linked to” another component, it may include an indirect connection where another element may be present therebetween as well as a direct connection. In addition, when a component “includes” or “has” another component, unless described to the contrary, the term “includes” or “has” does not indicate that the component excludes another component but instead indicates that the component may further include another component.

When a component, device, element, or the like of the present disclosure is described as having a purpose or performing an operation, function, or the like, the component, device, or element should be considered herein as being “configured to” meet that purpose or perform that operation or function.

In the present disclosure, terms such as first, second, etc., are used only for the purpose of distinguishing one component from other components. These terms do not limit the order or importance between components unless specifically mentioned. Therefore, within the scope of the present disclosure, a first component in one embodiment may be referred to as a second component in another embodiment, and similarly, a second component in one embodiment may be referred to as a first component in another embodiment.

In the present disclosure, distinct components are intended to clearly describe respective features, and do not necessarily mean that the components are separated. For example, a plurality of components may be integrated to form one hardware or software unit, or one component may be distributed to form a plurality of hardware or software units. Accordingly, even when not separately mentioned, such integrated or distributed embodiments are also included in the scope of the present disclosure.

In the present disclosure, components described in various embodiments do not necessarily mean essential components, and some may be optional components. Accordingly, embodiments constituted by a subset of components described in one embodiment are also included in the scope of the present disclosure. In addition, embodiments that include other components in addition to those described in various embodiments are also included in the scope of the present disclosure.

In the present disclosure, each of phrases such as “A or B,” “at least one of A and B,” “at least one of A or B,” “A, B or C,” “at least one of A, B and C,” and “at least one of A, B, C, or a combination thereof” may include any one of the items listed in the phrase, or all possible combinations of the items.

Advantages and features of the present disclosure, and methods for achieving the advantages and features are provided with reference to embodiments described below in detail together with the accompanying drawings. However, the present disclosure is not limited to the embodiments presented below. Rather, the present disclosure may be implemented in a variety of different forms. The described embodiments are only provided to make the present disclosure complete, and to completely inform those having ordinary skill in the art to which the present disclosure pertains of the scope of the present disclosure.

In addition, in the present specification, terms such as “module,” “unit,” “device,” “server,” etc. may be intended to refer to the functional and structural combination of hardware or software driven by or for driving the hardware. For example, the hardware may be a data processing device including a CPU or other processor. In addition, software driven by hardware may refer to a running process, object, executable, thread of execution, program, etc.

In the present disclosure, a “system” may include one or more computing devices and may be provided in local or cloud form, but is not limited thereto.

In the present disclosure, “security key provisioning” may refer to a process or operation of processing or providing a security key in a usable state to execute a process or security service provided by a hardware security module (HSM).

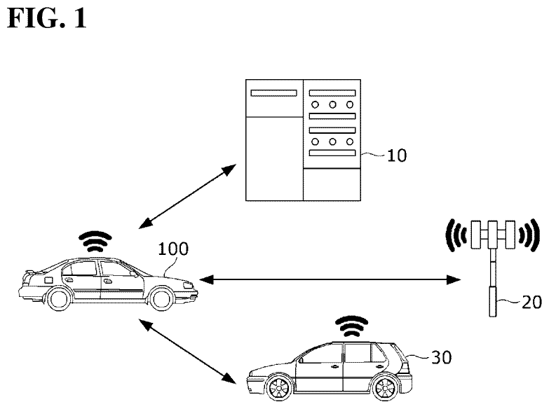

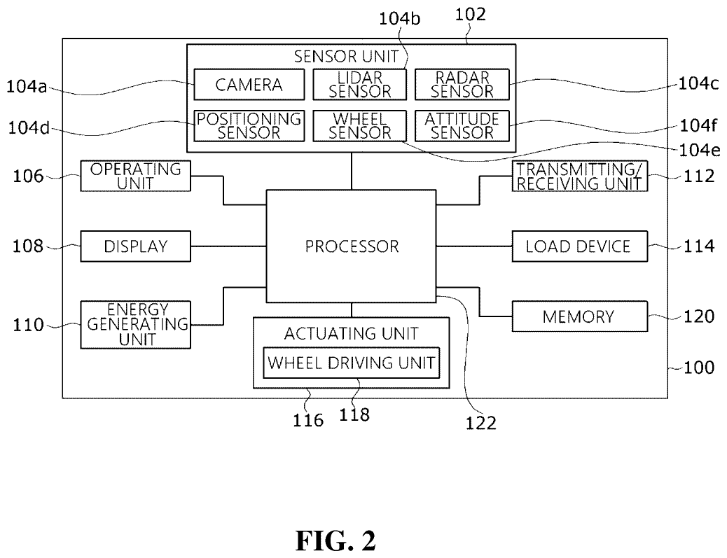

Hereinafter, a vehicle 100 in which a vehicle control device according to an embodiment of the present may be used is described with reference to FIGS. 1 and 2.

FIG. 1 is a view showing that the vehicle 100 transmits and receives data by communicating with another device.

Referring to FIG. 1, the vehicle 100 may be driven based on electrical energy or fossil energy. In the case of electrical energy, the vehicle 100 may be, for example, a pure battery-based vehicle powered only by a high-voltage battery, or may employ a gas-based fuel cell as an energy source. In addition, the fuel cell may use various types of gas capable of generating electrical energy, and the vehicle 100 may be filled with the gas in a liquefied state, for example. The gas may be hydrogen as one example. However, the gas is not limited thereto, and various gases are applicable. In the case of fossil energy, the vehicle 100 is driven based on fuel such as gasoline, diesel or liquefied gas, and may be equipped with an internal combustion engine that drives an actuating unit 116 by combustion of the fuel. The engine may be included in an energy generating unit 110 in terms of providing a driving rotational force of wheels to a wheel driving unit 118. As another example, the vehicle 100 may drive the actuating unit 116 by selectively utilizing energy from a fossil energy-based internal combustion engine and an electric battery, and may be a hybrid type vehicle.

The vehicle 100 may be a ground vehicle that travels on the ground. For example, the vehicle 100 may be a typical passenger car, a commercial vehicle, a purpose-built vehicle (PBV), or the like. The vehicle 100 may be a four-wheeled vehicle, such as a passenger car, a sport utility vehicle (SUV), or a small truck, or may be a vehicle with more than four wheels, such as a bus, a large truck, a container transport vehicle, a heavy equipment vehicle, or the like. Here, the ground vehicle may refer to a vehicle that move underground as well as a vehicle that moves over land. The vehicle 100 may be a robot in a broad sense, such as a means of movement, and the robot may be moved using wheels, tracks, or other movement modules. In the present disclosure, ground mobility devices such as ground vehicles are mainly described, but unless otherwise inconsistent with the present disclosure, the present embodiment may also be applied to air mobility devices such as AAMs, aircraft, or the like, and water mobility devices such as ships, submarines, or the like.

The vehicle 100 may be controlled and driven by autonomous driving, and autonomous driving may be implemented as semi-autonomous driving or fully autonomous driving. Fully autonomous driving may be provided as autonomous movement in which a processor 122 of the vehicle 100 takes full control without user intervention, even when a driving situation is uncertain. Semi-autonomous driving may be provided as autonomous movement that requires driver intervention depending on specific driving situations. Semi-autonomous driving may be implemented so that the processor 122 transfers control to a user while deactivating autonomous driving when the aforementioned situation occurs, allowing the user to perform manual driving. According to the levels of autonomous driving defined by the Society of Automotive Engineers (SAE), semi-autonomous driving may correspond to autonomous driving levels 1 to 4, and fully autonomous driving may correspond to level 5.

The vehicle 100 may communicate with other devices 10 and 20 or another vehicle 30. Other devices may include, for example, a server 10 that supports various controls, state management, and driving of the vehicle 100, an intelligent transportation system (ITS) device 20 for receiving information from an ITS, various types of user devices, or the like. The server 10 may be, for example, an external device operated by a vehicle manufacturer or provided to service autonomous driving, and may receive connected data of the vehicle 100 or transmit data necessary for autonomous driving. The server 10 may transmit various information and software modules used to control the vehicle 100 to the vehicle 100 in response to the request and data transmitted from the vehicle 100 and the user device to support autonomous driving and various services of the vehicle 100.

The ITS device 20 may be, for example, a roadside unit (RSU). The ITS device 20 may assist the user in driving his or her own vehicle or support autonomous driving of the vehicle 100 by exchanging vehicle recognition data, driving control and state data, environmental data around the vehicle, map data, or the like, through V2I with the vehicle 100. The vehicle 100 may support manual driving or autonomous driving by exchanging the data listed above through V2V with the other vehicle 30.

The vehicle 100 may communicate with other vehicles or other devices based on cellular communication, wireless access in vehicular environment (WAVE) communication, dedicated short range communication (DSRC), or short-range communication, or other communication methods.

For example, the vehicle 100 may use a cellular communication network such as LTE or 5G, WiFi communication network, WAVE communication network, or the like, for communication with the server 10, the ITS device 20, and the other vehicle 30. For another example, DSRC or the like used in the vehicle 100 may be used for communication between vehicles. The communication method between the vehicle 100, the server 10, the ITS device 20, the other vehicle 30, and the user device is not limited to the above-described embodiment.

FIG. 2 is a diagram showing modules constituting a vehicle according to one embodiment of the present disclosure.

A vehicle 100 may include a sensor unit 102, an operating unit 106, a display 108, a load device 114, a transmitting/receiving unit 112, an energy generating unit 110, an actuating unit 116, a memory 120, and a processor 122.

The sensor unit 102 may be provided with various types of detectors to detect various states and situations occurring in an external environment, an internal system, a user operation, and a boarding space of the vehicle 100.

For example, the sensor unit 102 may be provided with an externally oriented camera 104a, a lidar sensor 104b, a radar sensor 104c, and the like, to recognize dynamic and static objects existing outside the vehicle 100. The camera 104a may recognize an external object as an image while the vehicle 100 is in use, generate image data, and transmit the image data to the processor 122. The lidar sensor 104b may generate point cloud data as recognized data of the external object and transmit the point cloud data to the processor 122 to generate 3D spatial information that identifies at least a shape of the external object. In order to ascertain the presence of an external object and its relative distance, speed, direction, or the like, the radar sensor 104c may emit radio waves of a specific frequency around the vehicle 100 and generate radar data through radio waves reflected from the external object. In FIG. 2, the sensor unit is illustrated as having the lidar sensor 104b, but in other examples, the lidar sensor 104b may not be mounted.

The sensor unit 102 may be provided with a positioning sensor 104d, a wheel sensor 104e, an attitude sensor 104f, or the like, to confirm its own location, speed, driving attitude, and the like. The attitude sensor 104f may include a gyro sensor, an angular velocity sensor, an acceleration sensor, or the like.

The operating unit 106 may be configured as a module controlled by the user for driving. For example, the operating unit 106 may be a steering wheel for manual driving, an automatic or manual shift transmission, an accelerator pedal, a brake pedal, or the like. The operating unit 106 may be further provided with an interface for enabling or disabling an autonomous driving mode and selecting detailed functions requested by the user so that the user may use the autonomous driving function. In order to receive various requests related to autonomous driving, the operating unit 106 may be configured, for example, as a hard-type interface provided at a predetermined position inside the vehicle 100, or as a soft-type interface that capable of being touched on the display 108. Depending on the specifications of the autonomous vehicle, at least one of the steering wheel, the transmission, and the pedal may be omitted. For another example, the operating unit 106 may be provided with a module that receives a user's control request for the load device 114 in addition to driving control.

The display 108 may function as a user interface. The display 108 may output and display an operating state, a control state, route/traffic information, remaining energy amount information, content requested by the driver, or the like, of the vehicle 100 by the processor 122. In addition, the display 108 may be configured as a touch screen capable of detecting driver input to receive a driver's request to instruct the processor 122.

The load device 114 is mounted on the vehicle 100 and may be a type of non-driving electric device excluding a driving power system such as the wheel driving unit 118 or the like. The load device 114 is an auxiliary device that receives electric power from the energy generating unit 110, and may be, for example, an air conditioning system, a lighting system, a seat system, various devices installed in the vehicle 100, or the like. In an embodiment, a cooling/heating system that cools or heats at least one of the battery, the fuel cell, the internal combustion engine, the air conditioning system, and a specific part of the vehicle 100 may be further included.

The transmitting/receiving unit 112 may support mutual communication with the server 10, the ITS device 20, surrounding vehicles 20, and the like. The transmitting/receiving unit 112 may include a module that processes, for example, cellular communication, WAVE, DSRC communication, and the like. In an embodiment, the transmitting/receiving unit 112 may transmit data generated or stored while driving to the server 10 and receive data and software modules transmitted from the server 10. The transmitting/receiving unit 112 may support communication with an electronic device carried by an occupant inside the vehicle 100. In the present disclosure, the vehicle 100 may transmit and receive data utilized in a method according to the present disclosure to the outside through the transmitting/receiving unit 112.

The energy generating unit 110 may generate and supply power and electric power used in a driving power system and a non-driving power system, such as the actuating unit 116. The non-driving power system may be, for example, the sensor unit 102, the operating unit 106, the display 108, the load device 114, and the transmitting/receiving unit 112. However, the non-driving power system is not limited thereto, and may include various components that implement sensing, interface, communication, and convenience functions, excluding components directly involved in driving operations. When the vehicle 100 is driven based on electrical energy, the energy generating unit 110 may be configured as an electric battery charged from the outside, or configured as a combination of an electric battery and a fuel cell that charges the electric battery. In the case of the combination of the electric battery and the fuel cell, the energy generating unit 110 may include a tank that stores materials used to produce electric power for the fuel cell, such as liquefied hydrogen. When the vehicle 100 is driven based on fossil energy, the energy generating unit 110 may be configured as the internal combustion engine. In addition, when the vehicle 100 is a hybrid type, the energy generating unit 110 may be provided as a combination of the internal combustion engine and the electric battery.

The actuating unit 116 may be provided with at least one module that implements driving operations and perform at least one driving operation among longitudinal control such as acceleration and deceleration and lateral control such as steering, according to a user request from the operating unit 106. In order to perform driving operations according to a command of the processor 122 by a manual operation of the user or autonomous driving, the actuating unit 116 may be provided with the wheel driving unit 118 and mechanical components and electronic modules for implementing the driving operations in the wheel driving unit 118. When the vehicle 100 is operated based on electric energy, the actuating unit 116 may include an assembly for transmitting the requested driving operation to the wheel driving unit 118. When the vehicle 100 is operated based on fossil energy, the actuating unit 116 may be provided with a transmission and a gear module that transmit the power of the internal combustion engine.

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels. When the vehicle 100 is driven based on electrical energy, the driving force generating module may be configured as a motor assembly that generates a driving force based on electric power output from the electric battery. The braking module of the electric-based vehicle 100 may further have a regenerative braking function.

The memory 120 may store at least one program (e.g., operating system, software, firmware, middleware, or application, etc.), various data, and at least one command for controlling the vehicle 100, thereby making it possible to load a program, read or write data, or perform an operation corresponding to a command at the request of the processor 122. The memory 120 may include a volatile memory and a non-volatile memory.

The processor 122 may perform overall control of the vehicle 100 according to input commands. Commands may be input to the processor 122 through the memory 120 or the transmitting/receiving unit 112. As one example, the processor 122 may control operations of other components (hardware or software) connected to the vehicle 100 and perform data processing and calculations by executing programs or instructions stored in the memory 120. The processor 122 may include, for example, at least one of at least one central processing unit, at least one microprocessor, and at least one digital signal processor (DSP). In addition, the processor 122 may load commands or data received from other components (e.g., the sensor unit 102 or the transmitting/receiving unit 112) into the volatile memory, process the commands or data stored in the volatile memory, and store processing results in the non-volatile memory.

According to one embodiment, the vehicle 100 may be provided with at least one vehicle control device. At least one vehicle control device may be provided in the form of an embedded system inside the vehicle 100. When a plurality of vehicle control devices are provided, the vehicle control device may be implemented as independent devices for each function of the vehicle control device, or may be connected to communicate with each other. In addition, at least one vehicle control device may be implemented integrally with vehicle internal control units (e.g., the processor 122) or may be implemented as a separate and independent chip. As one example, at least one controlling device may be implemented in various forms such as an electronic control unit (ECU), micro controller unit (MCU), central processing unit (CPU), microprocessor, or the like.

A function capable of being controlled by at least one vehicle control device may be one of various vehicle control functions including engine control, transmission control, electronic stability control, airbag control, tire pressure monitoring system, motor control, seat control, door control, and the like.

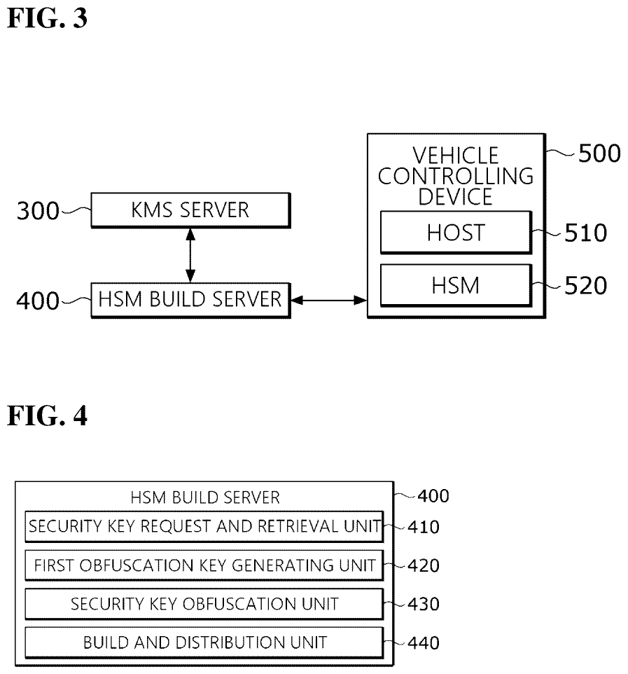

FIG. 3 is a diagram showing a security key provisioning system for vehicle control according to one embodiment of the present disclosure;

Referring to FIG. 3, the security key provisioning system for vehicle control may include a key management system (KMS) server 300, an HSM build server 400, and a vehicle control device 500. The KMS server 300 and the HSM build server 400 may be implemented to be integrated into one computing device, or may be implemented as a separate and independent computing device. Accordingly, the KMS server 300 and the HSM build server 400 may each include at least one memory and at least one processor (not shown in FIG. 3). In addition, although FIG. 3 shows the system including one vehicle control device 500, the system including a plurality of vehicle control devices is also possible.

The KMS server 300 may generate a security key to be injected into the vehicle control device 500 based on a request from the HSM build server 400. The KMS server 300 may map the identification information about the HSM build server 400 that has requested generation of the security key and the generated security key and may store the information and the security key.

The HSM build server 400 may request the KMS server 300 to generate the security key and may obfuscate the generated security key.

FIG. 4 is a block diagram showing the HSM build server 400 for security key provisioning according to one embodiment of the present disclosure shown in FIG. 3.

Referring to FIG. 4, the HSM build server 400 may include a security key request and retrieval unit 410, a first obfuscation key generating unit 420, a security key obfuscation unit 430, and a build and distribution unit 440.

The security key request and retrieval unit 410 may request the KMS server 300 to generate a security key and retrieve the security key generated and stored in the KMS server 300. The HSM build server 400 may retrieve the security key using the identification information (e.g., an ID of the HSM build server 400) used when requesting security key generation.

The first obfuscation key generating unit 420 may generate a first obfuscation key for obfuscating the retrieved security key. The first obfuscation key generating unit 420 may generate a first obfuscation key defined as a hash value using at least one of a unique ID within an HSM 520, information for identifying the HSM 520 (e.g., a serial number), a unique ID of the vehicle control device 500 to be provided with the HSM 520, and identification information used to request the KMS server 300 to generate a security key (e.g., a unique ID of the HSM build server 400). In order to ensure security, the first obfuscation key generating unit 420 may generate the first obfuscation key using white box cryptography (WBC) or using an encryption algorithm applied differently for each HSM 520.

The security key obfuscation unit 430 may generate an obfuscated security key by obfuscating the security key retrieved in the KMS server 300 using the generated first obfuscation key. In other words, the security key obfuscation unit 430 may data-encrypt the security key using the first obfuscation key.

The build and distribution unit 440 may inject the obfuscated security key into the HSM operating firmware to build and then distribute the HSM operating firmware (or HSM operating stack). In addition, the build and distribution unit 440 may distribute a public test security key together with the HSM operating firmware distribution. The build and distribution unit 440 may build and distribute the public test security key by injecting the public test security key into the HSM operating firmware. The public test security key is a security key capable of being used while the developer of the vehicle control device 500 develops the vehicle control device 500 using the HSM operating firmware, and it is not possible to use the public test security key when the vehicle control device 500 operates in a mass production mode (e.g., mass production mode).

As one example, the build and distribution unit 440 may build the HSM operating firmware by injecting an initial key (the security key generated in the KMS server 300 or a test security key), which is raw data, into a code area or data area of the HSM operating firmware, and in this case, a form of the completed build may be a binary form.

FIG. 5 is a block diagram showing the vehicle control device 500 for security key provisioning according to one embodiment of the present disclosure shown in FIG. 3.

Referring to FIG. 5, the vehicle control device 500 may include a host 510 for driving the vehicle control device 500 and the HSM 520 for security of the vehicle control device 500.

The host 510 may include a first memory 512 and a first processor 514.

The first memory 512 may store a plurality of programs including a boot loader for booting and driving the vehicle control device 500, at least one application, and an HSM driver.

The first processor 514 may boot the vehicle control device 500 and may control the driving of the vehicle control device 500 to perform functions assigned to the vehicle control device 500, or may process a plurality of items of data or a plurality of operations, such as performing processing to download and transmit the HSM operating firmware to the HSM 520 according to a command of a developer of the vehicle control device 500.

The HSM 520 may include a second memory 522 and a second processor 524.

The second memory 522 may include at least one of a volatile memory and a non-volatile memory and may store a plurality of programs that control the operation of the HSM 520. The plurality of programs stored in the second memory 522 may include the HSM operating firmware for operating the HSM 520. The HSM operating firmware may include at least one command for using a test security key in a development mode and an obfuscated security key in a production mode. In addition, the HSM operating firmware may generate a second obfuscation key and may include at least one command for de-obfuscation of the security key. In addition, the second memory 522 may store obfuscation information and the public test security key required to generate the second obfuscation key.

The second processor 524 may control the overall operation of the HSM 520. As one example, the second processor 524 may store the HSM operating firmware distributed by the HSM build server 400 in the second memory 522 and may execute the HSM operating firmware by a command of the developer of the vehicle control device 500. The second processor 524 may determine the operating mode of the HSM operating firmware and may perform processing so that the obfuscated security key included in the HSM operating firmware is selectively used based on the determined operating mode. The second processor 524 may perform processing so that one of the obfuscated security key and the public test security key is used depending on the operating mode of the HSM operating firmware. In addition, the second processor 524 may determine whether there is a history of previously generating the second obfuscation key, and may generate the second obfuscation key when there is no history of previously generating the second obfuscation key and de-obfuscate the security key using the generated second obfuscation key.

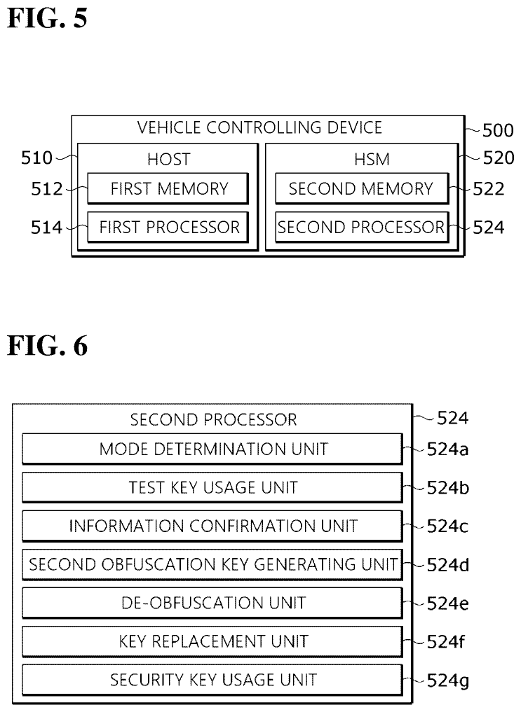

FIG. 6 is a diagram for describing a configuration of the second processor 524 of the vehicle control device 500 according to one embodiment of the present disclosure.

Referring to FIG. 6, the second processor 524 may include a mode determination unit 524a, a test key usage unit 524b, an information confirmation unit 524c, a second obfuscation key generating unit 524d, a de-obfuscation unit 524e, a key replacement unit 524f, and a security key usage unit 524g. Each component of the second processor 524 is a functionally distinct element to describe the operation of the second processor 524, and may be implemented in a physically independent form or in an integrated form. In addition, at least one of the mode determination unit 524a, the test key usage unit 524b, the information confirmation unit 524c, the second obfuscation key generating unit 524d, the de-obfuscation unit 524e, a key replacement unit 524f, and the security key usage unit 524g may be implemented as a command included in the HSM operating firmware.

The operating mode of the HSM 520 or the HSM operating firmware may include a development mode corresponding to a stage of developing the vehicle control device 500, the HSM 520, or the HSM operating firmware, and a production mode corresponding to a stage of mass producing the vehicle control device 500, the HSM 520, or the HSM operating firmware.

As one example, the developer may command switching of the operating mode through a menu provided by an HSM operating firmware supplier or a script provided by a chip manufacturer (a chip of the HSM 520 or a chip of the vehicle control device 500). The HSM 520 or the second processor 524 may change the operating mode using a mode change command received through an HSM application programming interface (API), and switching to the development mode may not be possible thereafter. As one example, at a final stage of the production process of the vehicle control device 500, the developer may command switching from the development mode to the production mode by setting Configuration Lock of the HSM operating firmware. The operating mode of the HSM operating firmware may not be switched back to the development mode after the operating mode is switched to the production mode.

As one example, hardware (e.g., the HSM 520) whose operating mode has been changed by setting an electronic fuse (eFuse) as hardware may be designed so that the operating mode is not possible to change back to the previous mode after switching to the production mode, and in the production mode, access to the HSM 520 from the host 510 and external devices (e.g., another vehicle control device, the processor 122, and the like) may be blocked.

The mode determination unit 524a may determine the operating mode set in the HSM operating firmware when the HSM operating firmware is executed. As one example, the mode determination unit 524a may determine the operating mode of the HSM operating firmware (e.g., the operating mode of the HSM 520) by confirming a flag corresponding to the operating mode, and may determine that the operating mode is the development mode when the flag is 0 and the operating mode is the production mode when the flag is 1. The mode determination unit 524a may activate the test key usage unit 524b when it is determined that the operating mode is the development mode, and may activate the information confirmation unit 524c when it is determined that the operating mode is the production mode.

When it is determined that the currently set operating mode is the development mode, the test key usage unit 524b may use a public test security key. As one example, when the developer performs a task that requires a security key during a development process stage of the vehicle control device 500, the test key usage unit 524b may perform the task using the test security key or cause the developer to perform the test by providing the test security key. Accordingly, the developer may perform the development process of the vehicle control device 500 in the development mode using the test security key.

When it is determined that the currently set operating mode is the production mode, the information confirmation unit 524c may determine whether there is a history of previously generating the second obfuscation key. When it is determined that there is no history of previously generating the second obfuscation key, the information confirmation unit 524c may confirm information required to generate the second obfuscation key in the second memory 522. The information required to generate the second obfuscation key is information used when generating the first obfuscation key, and may include at least one of a unique ID within an HSM 520, information for identifying the HSM 520 (e.g., a serial number), a unique ID of the vehicle control device 500 to be provided with the HSM 520, and identification information used to request the KMS server 300 to generate a security key (e.g., a unique ID of the HSM build server 400).

Since there is no history of previously generating the second obfuscation key, the second obfuscation key generating unit 524d may generate the second obfuscation key using the information confirmed by the information confirmation unit 524c. In this way, the second obfuscation key generating unit 524d may generate the second obfuscation key having the same configuration as the first obfuscation key generated in the HSM build server 400.

When the second obfuscation key generating unit 524d generates the second obfuscation key for the first time, the second obfuscation key generating unit 524d may record history information indicating that the second obfuscation key has first been generated in the second memory 522. The information confirmation unit 524c may determine whether there is the history of generating the second obfuscation key from the history information recorded in the second memory 522.

The de-obfuscation unit 524e may de-obfuscate the security key using the second obfuscation key generated in the second obfuscation key generating unit 524d. In other words, the de-obfuscation unit 524e may decrypt the obfuscated security key injected into the HSM operating firmware using the second obfuscation key. In this way, the de-obfuscation unit 524e may obtain a security key identical to the security key generated in the KMS server 300.

The key replacement unit 524f may replace the test security key used in the development mode with the security key de-obfuscated in the de-obfuscation unit 524e. As one example, the key replacement unit 524f may delete the test security key from the second memory 522 and replace the test security key by storing the de-obfuscated security key.

Then, the security key usage unit 524g may perform general operations of the HSM 520 (e.g., data encryption/decryption, certificate verification, and the like) using the de-obfuscated security key in the production mode.

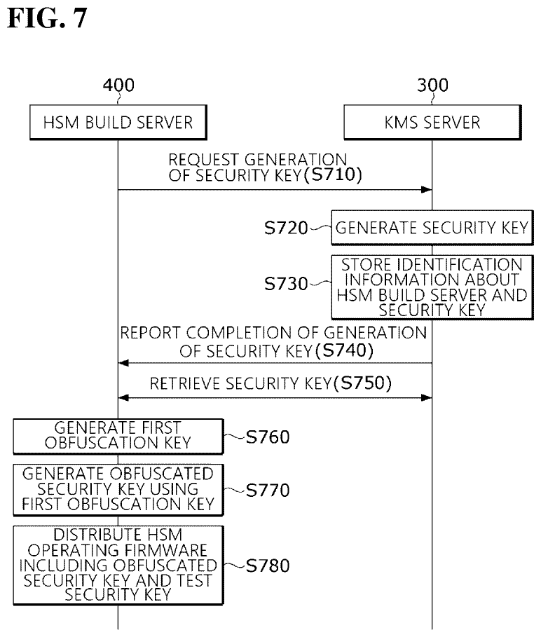

FIG. 7 is a flowchart for describing a method of generating a security key for security key provisioning according to one embodiment of the present disclosure.

Referring to FIG. 7, in an operation S710, the HSM build server 400 may request the KMS server 300 to generate a security key to be assigned to the vehicle control device 500. In the operation S710, the HSM build server 400 may request generation of the security key while transmitting identification information (e.g., a unique ID of the HSM build server 400) about the HSM build server 400 to the KMS server 300.

In an operation S720, the KMS server 300 may generate a security key to be injected into the vehicle control device 500 based on the request received in the operation S710.

In an operation S730, the KMS server 300 may map the identification information about the HSM build server 400 that has requested generation of the security key and the generated security key and store the information and the security key.

In an operation S740, the KMS server 300 may report to the HSM build server 400 that the generation of the security key has been completed. In some embodiments, the operation S740 may be omitted.

In an operation S750, the HSM build server 400 may retrieve the security key stored in the KMS server 300 using the identification information used when requesting the generation of the security key.

In an operation S760, the HSM build server 400 may generate a first obfuscation key to obfuscate the retrieved security key. In the operation S760, the first obfuscation key may be generated using at least one of a unique ID within the HSM 520, information for identifying the HSM 520 (e.g., a serial number), a unique ID of the vehicle control device 500 to be provided with the HSM 520, and identification information used to request the KMS server 300 to generate the security key.

In an operation S770, the HSM build server 400 may generate an obfuscated security key by obfuscating the security key retrieved in operation S750 using the first obfuscation key generated in operation S760.

In an operation S780, the HSM build server 400 may build the HSM operating firmware by injecting the obfuscated security key generated in operation S770 into the HSM operating firmware and distribute the HSM operating firmware in a downloadable form (S780).

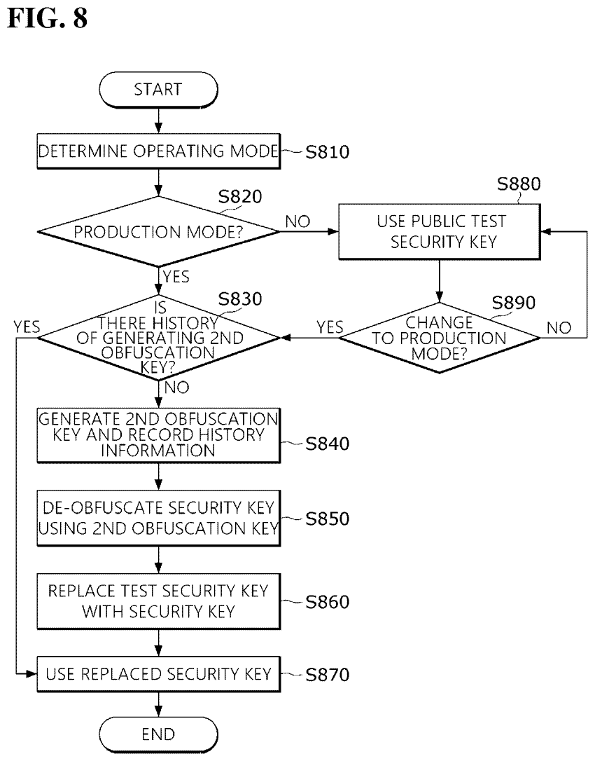

FIG. 8 is a flowchart for describing a method of provisioning a security key for vehicle control by the vehicle control device 500 according to one embodiment of the present disclosure.

The method of provisioning a security key for vehicle control shown in FIG. 8 may be performed by the second processor 524 of the vehicle control device 500 or the HSM 520 built in the vehicle control device 500, and with reference to FIG. 8, the second processor 524 is described as an example, but the method is not necessarily limited thereto.

Referring to FIG. 8, in an operation S810, when the HSM operating firmware is downloaded, installed, and executed, the second processor 524 of the HSM 520 may determine the operating mode set in the HSM operating firmware.

When it is determined that the operating mode is the production mode (YES in an operation S820), the second processor 524 may determine whether there is a history of previously generating a second obfuscation key in an operation S830. As one example, in the operation S830, the second processor 524 may determine that there is the history of generating a second obfuscation key when history information is stored in the second memory 522.

When it is determined that there is no history of previously generating the second obfuscation key (NO in the operation S830), the second processor 524 may confirm information required to generate the second obfuscation key in the second memory 522, generate the second obfuscation key using the confirmed information, and record the history information in the second memory 522 in an operation S840. The information confirmed in operation S840 may include at least one of a unique ID within the HSM 520, information for identifying the HSM 520 (e.g., a serial number), a unique ID of the vehicle control device 500 to be provided with the HSM 520, and identification information (e.g., a unique ID of the HSM build server 400) used to request the KMS server 300 to generate the security key. Accordingly, in the operation S840, the second obfuscation key having the same configuration as the first obfuscation key generated in operation S760 may be generated.

In an operation S850, the second processor 524 may de-obfuscate the security key injected into the HSM operating firmware using the second obfuscation key generated in the operation S840.

In an operation S860, the second processor 524 may replace the test security key used in the development mode with the security key de-obfuscated in the operation S850.

In an operation S870, the second processor 524 may perform general operations of the HSM 520 (e.g., data encryption/decryption, certificate verification, and the like) using the de-obfuscated security key in the production mode. Accordingly, in the production mode, the HSM operating firmware may use the changed obfuscated security key.

On the other hand, when the operating mode is determined as the development mode in the operation S810 (NO in the operation S820), the second processor 524 may perform processing so that the development process of the HSM 520 is performed using the public test security key in an operation S880.

When a command to change the operating mode to the production mode is input from the developer of the vehicle control device 500 or the HSM 520 (e.g., when Configuration Lock is set) (YES in an operation S890), the second processor 524 may proceed to the operation S830 to determine whether there is the history of previously generating the second obfuscation key and perform subsequent operations S830-S870.

The above-described example methods according to embodiments of the present disclosure are expressed as a series of operations for clarity of description, but it is not intended to limit the order in which the operations are performed, and as needed, each operation may be performed simultaneously or in a different order. In order to implement the methods according to embodiments of the present disclosure, other operations may be included in addition to the described operations, some operations may be excluded and the remaining operations may be included, or some operations may be excluded and additional other operations may be included.

The various embodiments of the present disclosure do not list all possible combinations but are intended to describe representative aspects of the present disclosure, and matters described in the various embodiments may be applied independently or in combination of two or more.

In addition, various embodiments of the present disclosure may be implemented by hardware, firmware, software, or a combination thereof. The hardware may be implemented by one or more application specific integrated circuits (ASICs), digital signal processors (DSPs), digital signal processing devices (DSPDs), programmable logic devices (PLDs), field programmable gate arrays (FPGAs), general processors, controllers, microcontrollers, microprocessors, or the like.

The scope of the present disclosure includes software or machine-executable instructions (e.g., an operating system, an application, firmware, a program, or the like) that cause operations according to various embodiments to be executed on a device or computer and a non-transitory computer-readable medium having the software or instructions stored thereon and executable on the device or computer.

According to embodiments of the present disclosure, a security key can be safely applied to a vehicle control device during a current production process (e.g., mass production process) without building separate infrastructure equipment or a separate process for security key provisioning, thereby saving product production costs and time and ensuring security of the vehicle control device.

In addition, according to embodiments of the present disclosure, the security of the security key can be ensured and maintained throughout the entire life cycle (e.g., development process and production process) of the vehicle control device. Accordingly, by differently applying the security key used depending on the life cycle, it is possible to prevent developers from extracting the security key through reverse engineering during the development process or production process.

In addition, according to embodiments of the present disclosure, since only the time for performing obfuscation key generation, de-obfuscation, and key replacement increases as the process performed by changing the life cycle of the HSM in the production process of the vehicle control device, it is possible to have no effect on the time for performing general operation of the HSM (data encryption/decryption, certificate verification, or the like) after production.

In addition, according to embodiments of the present disclosure, since the operating mode of the HSM cannot be changed back to a development mode after being converted to a production mode, in the production mode, the vehicle control device can perform general operations of an HSM or an HSM operating firmware (e.g., data encryption/decryption, certificate verification, or the like) using a de-obfuscated security key.

The effects obtainable from the present disclosure are not limited to the effects mentioned above. Other effects not mentioned herein should be clearly understood by those of ordinary skill in the art to which the present disclosure pertains from the following description.

What is claimed is:

1. A device for provisioning a security key for vehicle control, the device comprising:
at least one processor; and
a hardware security module (HSM) including at least one memory storing at least one program executable by the at least one processor,
wherein the at least one processor is configured to
determine an operating mode of an HSM operating firmware stored in the at least one memory, and
selectively use an obfuscated security key included in the HSM operating firmware based on the operating mode of the HSM operating firmware.

2. The device of claim 1, wherein the device is configured to communicate with an HSM build server, and wherein the HSM build server is configured to obfuscate a security key generated in a key management system (KMS) to generate the obfuscated security key.

3. The device of claim 2, wherein the HSM build server is configured to generate an obfuscation key and obfuscate the security key using the generated obfuscation key.

4. The device of claim 3, wherein the HSM build server is configured to inject the security key obfuscated using the obfuscation key into the HSM operating firmware.

5. The device of claim 1, wherein the at least one processor is configured to use one of the obfuscated security key or a public test security key depending on the operating mode of the HSM operating firmware.

6. The device of claim 5, wherein the operating mode of the HSM operating firmware includes a development mode corresponding to a stage of developing the device and a production mode corresponding to a stage of mass producing the device.

7. The device of claim 6, wherein the at least one processor is configured to use the public test security key when the operating mode of the HSM operating firmware is determined as the development mode.

8. The device of claim 6, wherein the at least one processor is configured to:
generate an obfuscation key when the operating mode of the HSM operating firmware is determined as the production mode;
de-obfuscate the obfuscated security key using the obfuscation key; and
replace a test security key used in the development mode with the de-obfuscated security key.

9. The device of claim 8, wherein the at least one processor is configured to:
determine whether there is a history of previously generating the obfuscation key when the operating mode of the HSM operating firmware is determined as the production mode; and
generate the obfuscation key when it is determined that there is no history of previously generating the obfuscation key.

10. The device of claim 8, wherein the at least one processor is configured to generate the obfuscation key identical to an obfuscation key used when the obfuscated security key is generated in an HSM build server.

11. A method of provisioning a security key for vehicle control, the method comprising:
determining, by a hardware security module (HSM) including a processor, an operating mode of an HSM operating firmware; and
selectively using, by the HSM, an obfuscated security key included in the HSM operating firmware based on the operating mode of the HSM operating firmware.

12. The method of claim 11, wherein an HSM build server obfuscates a security key generated in a key management system (KMS) and generates the obfuscated security key.

13. The method of claim 12, wherein the HSM build server generates an obfuscation key and obfuscates the security key using the generated obfuscation key.

14. The method of claim 13, wherein the HSM build server injects the security key obfuscated using the obfuscation key into the HSM operating firmware.

15. The method of claim 11, wherein selectively using the obfuscated security key includes using one of the obfuscated security key or a public test security key depending on the operating mode of the HSM operating firmware.

16. The method of claim 15, wherein the operating mode of the HSM operating firmware includes a development mode corresponding to a stage of developing a vehicle control device and a production mode corresponding to a stage of mass producing the vehicle control device.

17. The method of claim 16, wherein selectively using the obfuscated security key includes using the public test security key when it is determined that the operating mode is the development mode in the determining.

18. The method of claim 16, wherein selectively using obfuscated security key includes:
generating an obfuscation key when it is determined that the operating mode is the production mode;
de-obfuscating the obfuscated security key using the obfuscation key; and
replacing a test security key used in the development mode with the de-obfuscated security key and using the de-obfuscated security key.

19. The method of claim 18, wherein:
selectively using obfuscated security key further includes determining whether there is a history of previously generating the obfuscation key when it is determined that the operating mode is the production mode in the determining, and
generating the obfuscation key includes generating the obfuscation key when it is determined that there is no history of previously generating the obfuscation key.

20. The method of claim 18, wherein generating the obfuscation key includes generating the obfuscation key identical to an obfuscation key used when the obfuscated security key is generated in an HSM build server is generated.
